(19) United States
(12) Patent Application Publication
(10) Pub. No.: US 2024/0116107 A1
(43) Pub. Date: Apr. 11, 2024

(54) SINTERED METAL BODY AND METHOD FOR PRODUCING SINTERED METAL BODY

(71) Applicant: SEIKO EPSON CORPORATION, TOKYO (JP)

(72) Inventor: Taku KAWASAKI, KITAKYUSHU-SHI (JP)

(21) Appl. No.: 18/476,350

(22) Filed: Sep. 28, 2023

(30) Foreign Application Priority Data
Sep. 29, 2022 (JP) 2022-156027

(51) Int. Cl. B22F 7/04; B22F 3/10; B22F 3/22; B22F 3/24; B22F 7/00; C22C 38/00; C22C 38/02; C22C 38/04; C22C 38/20; C22C 38/22; C22C 38/26; C22C 38/42; C22C 38/44; C22C 38/48

(52) U.S. Cl. CPC B22F 7/04; B22F 3/1021; B22F 3/225; B22F 3/24; B22F 7/008; C22C 38/002; C22C 38/02; C22C 38/04; C22C 38/20; C22C 38/22; C22C 38/26; C22C 38/42; C22C 38/44; C22C 38/48; B22F 2003/241; B22F 2003/248; B22F 2007/045; B22F 2201/02; B22F 2301/35; B22F 2304/10; B22F 2998/10; B22F 2999/00

(57) ABSTRACT

A sintered metal body contains a composition of ferritic stainless steel, nitrogen, and impurities. The sintered metal body has an interstitial nitrogen solid solution layer which has an average thickness of 200 μm or more and in which nitrogen atoms are in a form of a solid solution, and a Vickers hardness at a position of a depth of 200 μm from a surface is 250 or more. In addition, a relative density may be 99.0% or more.

The present application is based on, and claims priority from JP Application Serial Number 2022-156027, filed Sep. 29, 2022, the disclosure of which is hereby incorporated by reference herein in its entirety.

### BACKGROUND

### 1. Technical Field

The present disclosure relates to a sintered metal body and a method for producing a sintered metal body.

### 2. Related Art

JP-A-2007-248398 discloses a decoration containing a base material mainly containing a Fe—Cr-based alloy and a film mainly containing M (M is one or two or more selected from Ti, Pt, Pd, Rd, Hf, V, Nb, Ta, Zr, Au, Ru, Cr, Cu, Fe, Al, and In).

JP-A-2007-248398 also discloses that a content of Ni in the base material of the decoration is 0.05 wt % or less, the base material has an austenitized layer obtained by austenitization by adding nitrogen atoms to the vicinity of a surface, and a thickness of the austenitized layer is 5 μm to 500 μm.

If the content ratio of Ni is within the above range, when the decoration is applied to an external component of a timepiece, movement of the timepiece can be less likely to be adversely affected by an external magnetic field. In addition, it is possible to effectively prevent occurrence of metal allergy caused by the external component of the timepiece.

Further, JP-A-2007-248398 discloses an austenitization treatment in which the vicinity of the surface of the base material is subjected to a heat treatment in a nitrogen atmosphere as a treatment for austenitization.

In the austenitization treatment, nitrogen atoms are added to the surface of the base material, and, when the addition of nitrogen atoms is insufficient, a thickness of a nitrogen solid solution layer cannot be sufficiently ensured. On the other hand, when the addition of nitrogen atoms is excessive, the nitrogen solid solution layer is denatured, and corrosion resistance of the base material decreases. Therefore, in the decoration disclosed in JP-A-2007-248398, it may be difficult to optimize a solid solution amount of nitrogen atoms in the nitrogen solid solution layer, and the corrosion resistance may not be sufficiently high.

### SUMMARY

A sintered metal body according to an application example of the present disclosure contains:
a composition of ferritic stainless steel;
nitrogen; and
impurities, in which
the sintered metal body has an interstitial nitrogen solid solution layer which has an average thickness of 200 μm or more and in which nitrogen atoms are in a form of a solid solution, and
a Vickers hardness at a position of a depth of 200 μm from a surface is 250 or more.

A method for producing a sintered metal body according to an application example of the present disclosure includes:
preparing an untreated sintered body containing a composition of ferritic stainless steel and impurities and having, on a surface thereof, a dense layer having an average thickness of 150 μm or more; and
subjecting the untreated sintered body to a nitrogen absorption treatment to form a solid solution of nitrogen atoms in the dense layer and obtain a sintered metal body having an interstitial nitrogen solid solution layer having an average thickness of 200 μm or more.

### BRIEF DESCRIPTION OF THE DRAWINGS

FIG. 1 is a partially enlarged cross-sectional view schematically showing the vicinity of a surface layer of a sintered metal body according to an embodiment.

FIG. 2 is a graph showing an example of a depth distribution of a Vickers hardness of the sintered metal body.

FIG. 3 is a step chart showing a method for producing a sintered metal body.

FIG. 4 is an observation image of a cut surface of a sintered metal body in Sample No. 1.

FIG. 5 is an observation image of a cut surface of a sintered metal body in Sample No. 12.

FIG. 6 is a graph showing a relationship between a potential and a current density obtained from the sintered metal body in Sample No. 1 (Example) and a relationship between a potential and a current density obtained from the sintered metal body in Sample No. 12 (Comparative Example).

### DESCRIPTION OF EMBODIMENTS

Hereinafter, a sintered metal body and a method for producing a sintered metal body according to the present disclosure will be described in detail with reference to the accompanying drawings.

### 1. Sintered Metal Body

A sintered metal body according to an embodiment will be described.

The sintered metal body according to the embodiment contains a composition of ferritic stainless steel, N (nitrogen), and impurities. Such a sintered metal body is produced by a powder metallurgy technique. In the powder metallurgy technique, a composition containing a sintering metal powder and a binder is molded into a desired shape, and then subjected to a debindering treatment and a sintering treatment, whereby a sintered metal body having a desired shape can be obtained. Accordingly, a sintered metal body having a complicated and fine shape can be produced in a near-net shape, that is, a shape close to a final shape. In addition, in the composition of ferritic stainless steel, a content of Ni is substantially zero. Therefore, the sintered metal body according to the embodiment has an advantage of being Ni-free.

### 1.1. Structure

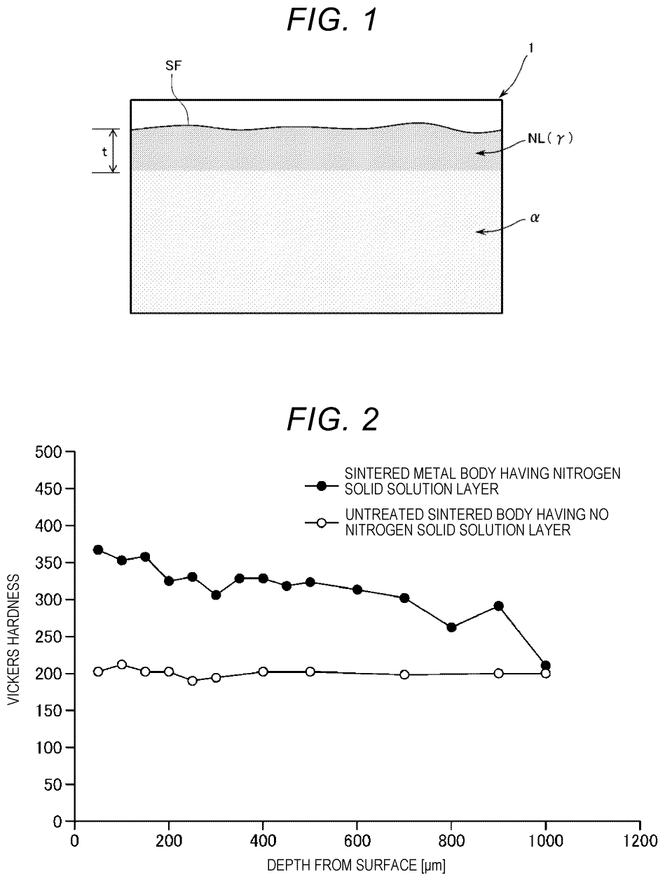

FIG. 1 is a partially enlarged cross-sectional view schematically showing the vicinity of a surface layer of a sintered metal body 1 according to the embodiment.

The sintered metal body 1 shown in FIG. 1 has an interstitial nitrogen solid solution layer NL located in the vicinity of a surface SF. The interstitial nitrogen solid solution layer NL is a region in which a part of a ferrite structure a is austenitized by solid solution of nitrogen from the surface SF side. The interstitial nitrogen solid solution layer NL mainly contains an austenite structure y, is insusceptible to corrosion, and thus has excellent corrosion resistance.

In the sintered metal body 1, since a thickness t of the interstitial nitrogen solid solution layer NL is sufficiently large, the corrosion resistance is particularly favorable. An average thickness of the interstitial nitrogen solid solution layer NL is 200 μm or more, preferably 250 μm or more, and more preferably 300 μm or more.

An upper limit value of the average thickness of the interstitial nitrogen solid solution layer NL may not be particularly set, and may be set to, for example, 3000 μm, preferably 2000 μm in consideration of a depth at which solid solution of nitrogen is stable.

The average thickness of the interstitial nitrogen solid solution layer NL is a value obtained by averaging the thickness t measured at 10 or more positions. The thickness t is measured as follows.

First, a cross-section of the sintered metal body 1 is observed with an optical microscope. By the optical microscope, a ferrite structure and an austenite structure can be distinguished from each other by a color tone and a crystalline state. Next, a thickness of the austenite structure from the surface SF is measured. This measured value is the thickness t of the interstitial nitrogen solid solution layer NL.

### 1.2. Composition

Examples of the composition of ferritic stainless steel include chemical components defined in the JIS standards. In the JIS standards, a steel type of ferritic stainless steel is represented by a symbol. Examples of the steel type include SUS405, SUS410L, SUS429, SUS430, SUS430F, SUS430LX, SUS430J1L, SUS443J1, SUS434, SUS436J1L, SUS436L, SUS444, SUS445J1, SUS445J2, SUSXM27, SUS447J1, SUH409, and SUH409L.

N (nitrogen) may be contained within a range defined by the JIS standards, or may be contained beyond the range defined by the JIS standards. N is added by a treatment of absorption from the surface toward inside of the sintered metal body 1. Due to the absorption of N, a structure of the sintered metal body 1 changes from a ferrite structure to an austenite structure. Accordingly, the surface of the sintered metal body 1 is provided with a favorable hardness and favorable corrosion resistance due to the austenite structure.

A content of each element in the sintered metal body 1 according to the embodiment is preferably as follows.
Content of C: 0.02 mass % or more and 1.00 mass % or less
Content of Si: 1.00 mass % or less
Content of Mn: 1.00 mass % or less
Content of P: 0.03 mass % or less
Content of S: 0.02 mass % or less
Content of Cr: 12.0 mass % or more and 30.0 mass % or less
Content of Nb: 0.05 mass % or more and 1.50 mass % or less
Content of N: 1.00 mass % or less

A remainder other than the above elements is Fe and impurities.

In particular, the content of N is more preferably 0.05 mass % or more and 0.80 mass % or less, and still more preferably 0.15 mass % or more and 0.70 mass % or less. When the content of N is within the above range, nitrogen can be subjected to solid solution with a sufficient thickness from the surface of the sintered metal body 1, and precipitation of a by-product due to excessive N and deterioration of corrosion resistance and mechanical properties due to the precipitation can be inhibited. Accordingly, it is possible to achieve a sufficiently high hardness and high corrosion resistance of the sintered metal body 1.

C (carbon) may be contained within a range defined by the JIS standards, or may be contained beyond the range defined by the JIS standards. C reduces a substance that inhibits sintering, for example, an oxide such as a silicon oxide or a chromium oxide. Examples of a reduction reaction of the oxide include a reaction represented by the following reaction formulas.

SiO₂(s)+C(s)→SiO(g)+CO(g)

Cr₂O₃(s)+3C(s)→2Cr(s)+3CO(g)

In the above formulas, (s) represents a solid, and (g) represents a gas. In this example, the silicon oxide SiO₂ reacts with carbon C, changes into a substance that is easily vaporized, and is removed from a molded body. In addition, the chromium oxide is reduced to metal chromium. As a result, it is possible to reduce the oxide that is likely to inhibit sintering from the molded body, and thus it is possible to increase a density of the sintered metal body 1.

On the other hand, in the reduction reaction, a gas is generated as a by-product. The gas may remain inside the sintered metal body 1. Therefore, in the sintered metal body 1 according to the present embodiment, C and Nb (niobium) are used in combination, and thus the remaining of the gas is inhibited.

Specifically, by using C (carbon) and Nb (niobium) in combination, NbC (niobium carbide) is precipitated on a particle surface of a sintering metal powder during sintering. Such NbC can slow down a sintering rate when the sintering metal powder is sintered, and inhibits rapid sintering progress on a surface of the molded body (debindered body). Accordingly, it is possible to reduce a difference in the sintering progress between the surface and the inside of the molded body, inhibit the gas from remaining inside, and cause a thicker dense layer to be formed on the surface. The dense layer contributes to inhibiting rapid nitrogen absorption in a nitrogen absorption treatment performed after the sintering treatment. The inhibition of rapid nitrogen absorption leads to inhibition of generation of a by-product such as Cr₂N and improvement in the corrosion resistance of the interstitial nitrogen solid solution layer NL. The method of forming the dense layer is not limited to the above-described method. For example, the sintering rate may be slowed down by a precipitate other than NbC.

The content of C is more preferably 0.05 mass % or more and 0.50 mass % or less, and still more preferably 0.08 mass % or more and 0.30 mass % or less. When the content of C is less than the lower limit value, an amount of C is insufficient with respect to an amount of Nb, and depending on contents of the other elements, the reduction reaction described above may be less likely to occur, or precipitation of NbC may be reduced. On the other hand, when the content of C exceeds the upper limit value, the amount of C is excessive with respect to the amount of Nb, and depending on the contents of the other elements, a sintering reaction may be hindered, and a sintering density may decrease. In addition, in the sintered metal body 1, a precipitate that deteriorates the corrosion resistance may easily be generated.

The content of Nb is preferably 0.10 mass % or more and 1.20 mass % or less, and more preferably 0.15 mass % or more and 0.70 mass % or less. When the content of Nb is less than the lower limit value, the amount of Nb is insufficient with respect to the amount of C, so that the dense layer may be thin and the interstitial nitrogen solid solution layer NL may also be thin. On the other hand, when the content of Nb exceeds the upper limit value, the amount of Nb is excessive with respect to the amount of C, the sintering density may be low or a precipitate may easily be generated, so that the hardness and the corrosion resistance may be reduced.

When a ratio of the content of C to the content of Nb is C/Nb, C/Nb is preferably 0.10 or more and 1.80 or less, more preferably 0.20 or more and 1.20 or less, and still more preferably 0.30 or more and 1.00 or less. Accordingly, a balance between the content of C and the content of Nb can be optimized. As a result, the sintered metal body 1 contains an appropriate amount of NbC, contains a thicker dense layer, and has a high sintering density. When the thick dense layer is obtained, the interstitial nitrogen solid solution layer NL having a sufficient thickness is finally obtained.

When a sum of the content of C and the content of Nb is C+Nb, C+Nb is preferably 0.20 mass % or more and 1.50 mass % or less, more preferably 0.25 mass % or more and 1.20 mass % or less, and still more preferably 0.30 mass % or more and 0.80 mass % or less. Accordingly, NbC can be appropriately precipitated, and the sintered metal body 1 having a high density as a whole and having a sufficiently thick dense layer can be obtained.

The content of Si (silicon) is 1.00 mass % or less as described above, preferably 0.20 mass % or more and 0.80 mass % or less, and more preferably 0.30 mass % or more and 0.50 mass % or less. Accordingly, the sintering density of the sintered metal body 1 can be further increased.

The content of Cr (chromium) is 12.0 mass % or more and 30.0 mass % or less as described above, preferably 15.0 mass % or more and 25.0 mass % or less, and more preferably 18.0 mass % or more and 23.0 mass % or less. Accordingly, the corrosion resistance and heat resistance of the sintered metal body 1 can be improved.

The sintered metal body 1 may contain at least one of Mo, Ni, Al, Ti, Cu, and Zr as necessary.

A content of Mo (molybdenum) is preferably 3.00 mass % or less, more preferably 0.70 mass % or more and 2.80 mass % or less, and still more preferably 1.80 mass % or more and 2.60 mass % or less.

A content of each of Ni (nickel), Al (aluminum), Ti (titanium), Cu (copper), and Zr (zirconium) is preferably 1.00 mass % or less, and more preferably 0.10 mass % or more and 0.80 mass % or less.

Fe (iron) and impurities occupy a remainder other than the components described above.

Among these, Fe is a main component of the sintered metal body 1 and has the highest content. The content of Fe is preferably 60 mass % or more, and more preferably 70 mass % or more.

A concentration of the impurities is preferably 0.10 mass % or less, and more preferably 0.05 mass % or less for each element. In addition, a total concentration of the impurities is preferably 1.00 mass % or less. Within this range, an element that is inevitably mixed or an element that is intentionally added can be regarded as an impurity since an effect of the sintered metal body 1 is not affected.

The impurities may contain O (oxygen). A concentration of oxygen is preferably 0.50 mass % or less, and more preferably 0.30 mass % or less. At this level, even if O is contained, characteristics of the sintered metal body 1 are not affected.

### 1.3. Analysis Method

The above composition is identified by the following analysis method.

Examples of the analysis method include iron and steel-atomic absorption spectrometric method defined in JIS G 1257:2000, iron and steel-ICP atomic emission spectrometric method defined in JIS G 1258:2007, iron and steel-method for spark discharge atomic emission spectrometric analysis defined in JIS G 1253:2002, iron and steel-method for X-ray fluorescence spectrometric analysis defined in JIS G 1256:1997, and gravimetric, titration, absorption spectrophotometric methods defined in JIS G 1211 to G 1237.

Specifically, examples include a solid-state emission spectrometer manufactured by SPECTRO Corporation, particularly a spark discharge emission spectrometer, model: SPECTROLAB, type: LAVMB08A, and an ICP apparatus CIROS 120 manufactured by Rigaku Corporation.

In particular, in order to identify C (carbon) and S (sulfur), an oxygen flow combustion (high-frequency induction heating furnace combustion)-infrared absorption method defined in JIS G 1211:2011 is also used. Specifically, examples include a carbon/sulfur elemental analyzer CS-200 manufactured by LECO Corporation.

Further, in particular, in order to identify N (nitrogen) and O (oxygen), iron and steel-methods for determination of nitrogen content defined in JIS G 1228:1997 and general rules for determination of oxygen in metallic materials defined in JIS Z 2613:2006 are also used. Specifically, examples include an oxygen/nitrogen elemental analyzer TC-300/EF-300 manufactured by LECO Corporation and an oxygen/nitrogen/hydrogen elemental analyzer ONH836 manufactured by LECO Corporation.

### 1.4. Characteristics

In the sintered metal body 1, a Vickers hardness at a position of a depth of 200 μm from the surface SF is 250 or more. The sintered metal body 1 having such a hardness is Ni-free and has a sufficiently high surface hardness. Therefore, the sintered metal body 1 having high wear resistance is obtained. In particular, since the position of a depth of 200 μm from the surface SF is sufficiently deep from the surface SF, the position is hardly affected by a precipitate precipitated in the vicinity of the surface SF, and is a position where physical properties derived from a matrix phase of the interstitial nitrogen solid solution layer NL can be measured. Therefore, when the Vickers hardness measured at this position is within the above range, it is confirmed that the austenite structure is stable to a sufficiently deep position in the interstitial nitrogen solid solution layer NL.

The Vickers hardness at the above position is measured as follows.

First, as described above, the cross-section of the sintered metal body 1 is observed with an optical microscope. Next, the Vickers hardness is measured at a position of a depth of 200 μm from the surface SF. A Vickers hardness meter is used as a hardness tester. In addition, a measurement load is 5 kgf (49 N), and a load holding time is 10 seconds.

The Vickers hardness at the above position is preferably 275 or more, and more preferably 300 or more.

FIG. 2 is a graph showing an example of a depth distribution of the Vickers hardness of the sintered metal body 1. In FIG. 2, a depth distribution of a Vickers hardness obtained for the sintered metal body 1 having the interstitial nitrogen solid solution layer NL and a depth distribution of a Vickers hardness obtained for an untreated sintered body before forming the interstitial nitrogen solid solution layer NL are shown together.

As shown in FIG. 2, the interstitial nitrogen solid solution layer NL acts to increase the Vickers hardness to a depth of about 1000 μm. At a position of a depth of 200 μm, the Vickers hardness before the formation of the interstitial nitrogen solid solution layer NL is about 200, whereas the Vickers hardness after the formation of the interstitial nitrogen solid solution layer NL is about 325.

In the example in FIG. 2, the Vickers hardness at a position of a depth of 400 μm from the surface SF is about 325. Therefore, in the example in FIG. 2, a difference between the Vickers hardness at a position of a depth of 200 μm and the Vickers hardness at a position of a depth of 400 μm is zero. In the sintered metal body 1 as in this example, the difference between the Vickers hardness at a position of a depth of 200 μm and the Vickers hardness at a position of a depth of 400 μm is preferably 100 or less, and more preferably 50 or less. The Vickers hardness represents a change in a metal structure in a depth direction from the surface SF of the sintered metal body 1. When the difference in the Vickers hardness between the two positions is within the above range, it is understood that an austenite is formed to a sufficient depth and the metal structure is gradually changed from an austenite structure to a ferrite structure. That is, when the difference in the Vickers hardness between the two positions is within the above range, the corrosion resistance and the surface hardness are improved over the entire surface of the sintered metal body 1.

A relative density of the sintered metal body 1 is preferably 99.0% or more, and more preferably 99.5% or more. When the relative density of the sintered metal body is within the above range, mechanical properties, the hardness, and the corrosion resistance of the sintered metal body are particularly favorable. The relative density of the sintered metal body 1 is measured by the Archimedes method.

The corrosion resistance of the sintered metal body 1 can be evaluated according to method B among methods of pitting potential measurement for stainless steel defined in JIS G 0577:2014. Method B is a pitting potential measurement method implemented by an electrokinetic potential method in a 3.5 mass % sodium chloride aqueous solution. Then, a pitting potential at which a current density of the sintered metal body 1 is 100 μA/cm² is measured by method B. That is, a potential at which the current density is 100 μA/cm² is set, for convenience, as a potential at which corrosion starts to progress, that is, a pitting potential. In addition, the pitting potential is set to a reference value of a saturated calomel electrode (SCE). The sodium chloride aqueous solution has a pH of 7 and a temperature of 30° C. In addition, a potential sweep rate is 20 mV/min.

The pitting potential of the sintered metal body 1 measured by such a method is preferably 700 mV or more, more preferably 800 mV or more, and still more preferably 900 mV or more. When the pitting potential is within the above range, corrosion of the sintered metal body 1 is sufficiently inhibited, and particularly favorable corrosion resistance is obtained.

An upper limit value of the pitting potential may not be particularly set, and is preferably 2000 mV from the viewpoint of reducing individual differences.

The sintered metal body 1 as described above is used as a material constituting all or a part of, for example, a transportation equipment component such as an automobile component, a bicycle component, a railway vehicle component, a ship component, an aircraft component or a space transporter component, an electronic device component such as a personal computer component, a mobile phone terminal component, a tablet terminal component or a wearable terminal component, a component for electrical equipment such as a refrigerator, a washing machine or an air conditioner, a component for a machine such as a machine tool or a semiconductor manufacturing apparatus, a component for a plant such as a nuclear power plant, a thermal power plant, a hydroelectric power plant, an oil refinery or a chemical combination, a timepiece component, metalware, a decoration such as a jewelry decoration or an eyeglass frame, or a medical instrument such as a medical scalpel or forceps.

### 2. Sintering Metal Powder

Next, an example of a sintering metal powder for producing the above-described sintered metal body 1 will be described.

As the sintering metal powder, a powder having a composition corresponding to the sintered metal body 1 to be produced is used. Therefore, a powder in which C and Nb are added as necessary to the composition of ferritic stainless steel is used as the sintering metal powder. In addition, if necessary, an amount of C (carbon) may be larger than that in the composition of the sintered metal body 1. Since C is consumed in the process of producing the sintered metal body 1, C is preferably added in consideration of the consumption.

Ferritic stainless steel originally has a high diffusion rate. Therefore, in a molded body containing a ferritic stainless steel powder, a difference in sintering progress tends to occur between the surface and the inside. In this case, sintering is completed earlier on the surface than the inside, and a gas generated due to the sintering remains inside. As a result, a dense layer in which sintering is completed (the dense layer) is formed extremely thin in a surface layer, whereas the inside becomes a region having a low density due to the remaining gas. In this case, the dense layer is extremely thin.

In this regard, the sintering rate can be slowed down by using the sintering metal powder in which the amounts of C and Nb are adjusted as described above. Accordingly, the difference in the sintering progress between the surface and the inside is reduced. As a result, it is possible to inhibit the gas from remaining inside and to thicken the dense layer formed on the surface. Such a thick dense layer has an effect of inhibiting rapid absorption of nitrogen in a nitrogen absorption treatment to be described later. This effect can inhibit generation of a by-product such as Cr₂N caused by the rapid absorption of nitrogen. Accordingly, it is possible to obtain the interstitial nitrogen solid solution layer NL containing a small amount of the by-product, and to obtain the sintered metal body 1 having high corrosion resistance. In addition, by inhibiting the generation of the by-product, denseness and uniformity of the interstitial nitrogen solid solution layer NL can be further improved, and the sintered metal body 1 having a higher surface hardness can be obtained.

An average particle diameter of the sintering metal powder is not particularly limited, and is preferably 0.5 μm or more and 30.0 μm or less, more preferably 0.5 μm or more and 15.0 μm or less, and still more preferably 1.0 μm or more and 10.0 μm or less. Accordingly, further densification can be achieved in the interstitial nitrogen solid solution layer NL formed in the sintered metal body 1.

When the average particle diameter of the sintering metal powder is less than the lower limit value, the powder is likely to aggregate and a filling property deteriorates, and thus a sintering density may decrease. On the other hand, when the average particle diameter of the sintering metal powder exceeds the upper limit value, the filling property at the time of molding deteriorates, and thus the sintering density may decrease.

The average particle diameter refers to a particle diameter D50 where a cumulative frequency is 50% from a small-diameter side in a cumulative particle size distribution on a volume basis of the sintering metal powder obtained using a laser diffraction type particle size distribution measuring apparatus.

With respect to the sintering metal powder, in the cumulative particle size distribution described above, (D90−D10)/D50 is preferably approximately 1.0 or more and 2.5 or less, and more preferably approximately 1.2 or more and 2.3 or less, in which D10 is a particle diameter when a cumulative frequency is 10% from the small-diameter side and D90 is a particle diameter when a cumulative value from the small-diameter side is 90%. (D90−D10)/D50 is an index indicating a degree of spread of the particle size distribution, and when this index is within the above range, the filling property of the sintering metal powder is particularly favorable. As a result, the sintered metal body 1 having a high density can be produced.

### 3. Method for Producing Sintered Body

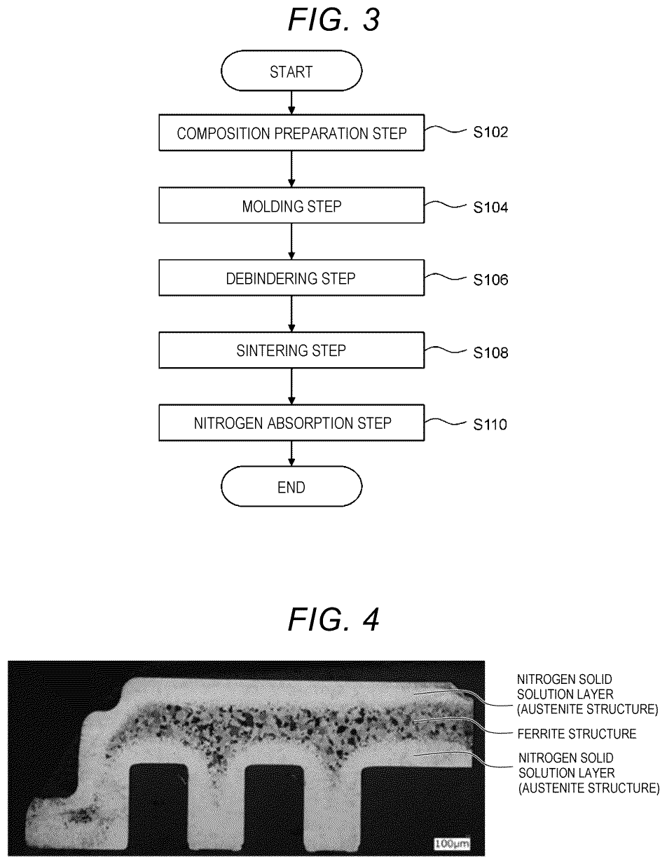

FIG. 3 is a step chart showing a method for producing the sintered metal body 1.

The method for producing the sintered metal body 1 shown in FIG. 3 includes a composition preparation step S102, a molding step S104, a debindering step S106, a sintering step S108, and a nitrogen absorption step S110. Hereinafter, each step will be sequentially described.

### 3.1. Composition Preparation Step

In the composition preparation step S102, a molding composition containing a sintering metal powder and an organic binder is obtained.

The sintering metal powder is preferably produced by an atomization method, and more preferably produced by a water atomization method or a rotary water flow atomization method. The atomization method is a method of producing a metal powder by causing a molten metal to collide with a liquid or a gas injected at a high speed to pulverize and cool the molten metal. When the sintering metal powder is produced by the atomization method, a fine powder can be efficiently produced.

The sintering metal powder may be subjected to various pretreatments such as a heat treatment, a plasma treatment, an ozone treatment, and a reduction treatment.

As the organic binder, a resin that can be decomposed in a short time in a debindering treatment and a sintering treatment is used. Examples of the resin include polyolefins such as polyethylene, polypropylene, and ethylene-vinyl acetate copolymers, acrylic resins such as polymethyl methacrylate and polybutyl methacrylate, styrene resins such as polystyrene, polyesters such as polyvinyl chloride, polyvinylidene chloride, polyamide, polyethylene terephthalate, and polybutylene terephthalate, polyethers, polyvinyl alcohols, polyvinyl pyrrolidone, copolymers thereof, various waxes, paraffins, higher fatty acids, higher alcohols, higher fatty acid esters, and higher fatty acid amides, and one or more of these can be used in a mixture.

Examples of a form of the molding composition include a kneaded material and a granulated powder.

A mixing ratio of the organic binder is preferably approximately 0.2 mass % or more and 20.0 mass % or less of the molding composition, and more preferably approximately 0.5 mass % or more and 15.0 mass % or less.

In addition to the above components, various additives such as a plasticizer, a lubricant, an antioxidant, a debindering accelerator, and a surfactant may be added to the composition.

### 3.2. Molding Step

In the molding step S104, the molding composition is molded into a desired shape. Accordingly, a molded body is obtained.

Examples of a molding method include an injection molding method, a compression molding method, an extrusion molding method, and an additive manufacturing method. Among these, examples of the additive manufacturing method include a material extrusion deposition method and a binder jetting method.

### 3.3. Debindering Step

In the debindering step S106, a debindering treatment is performed on the molded body to obtain a debindered body.

Examples of the debindering treatment include a method of heating the molded body to decompose the organic binder, and a method of exposing the molded body to a gas that decomposes the organic binder. All or a part of the organic binder in the molded body is removed by the debindering treatment.

When the method of heating the molded body is used, a heating condition of the molded body slightly varies depending on a composition and a blending amount of the organic binder, a temperature is preferably 100° C. or higher and 750° C. or lower, a time is preferably 0.1 hours or longer and 20 hours or shorter, the temperature is more preferably 150° C. or higher and 600° C. or lower, and the time is more preferably 0.5 hours or longer and 15 hours or shorter.

An atmosphere when heating the molded body is not particularly limited, and examples thereof include an inert atmosphere such as nitrogen or argon, an oxidizing atmosphere such as air, and a depressurized atmosphere obtained by depressurizing such an atmosphere.

As the method of exposing the molded body to a gas that decomposes the organic binder, for example, an acid debindering method is used. The acid debindering method is a method in which the molded body is heated in an acid-containing atmosphere to perform debindering using a catalytic action of an acid. According to the acid debindering method, since the organic binder can be decomposed in a short time even at a low temperature, the debindering treatment can be efficiently performed even for a molded body having a large volume.

The acid-containing atmosphere refers to an atmosphere containing an acid capable of decomposing the organic binder. Examples of the acid include nitric acid, oxalic acid, and ozone, and one or two or more of these can be used in combination. In addition, a mixed gas obtained by mixing these acids and another gas may be used. An example of the mixed gas is fuming nitric acid. A pressure of the atmosphere may be an atmospheric pressure, a reduced pressure, or an increased pressure.

A heating condition of the molded body in the acid-containing atmosphere is of a lower temperature or a shorter time than the heating condition described above. Therefore, an amount of heat applied to the molded body can be reduced, and oxidation of the sintering metal powder can be easily inhibited.

### 3.4. Sintering Step

In the sintering step S108, the debindered body is subjected to a sintering treatment to obtain an untreated sintered body. The untreated sintered body refers to an object to be treated which is to be subjected to a nitrogen absorption treatment to be described later. The untreated sintered body contains the above-described ferritic stainless steel composition and impurities, and has a dense layer having an average thickness of 150 μm or more on a surface thereof.

A sintering temperature varies depending on a composition ratio, a particle diameter, and the like of the sintering metal powder, and is, for example, approximately 980° C. or higher and 1330° C. or lower. In addition, the temperature is preferably approximately 1050° C. or higher and 1260° C. or lower.

A sintering time is 0.2 hours or longer and 7 hours or shorter, and preferably approximately 1 hour or longer and 6 hours or shorter.

Examples of an atmosphere in the sintering treatment include a reducing atmosphere such as hydrogen, an inert atmosphere such as nitrogen or argon, and a depressurized atmosphere obtained by depressurizing such an atmosphere. A pressure of the depressurized atmosphere is not particularly limited as long as the pressure is less than an ambient pressure (100 kPa), is preferably 10 kPa or less, and more preferably 1 kPa or less. Accordingly, a gas remaining in the debindered body can be discharged particularly efficiently, and a density of the finally obtained sintered metal body 1 can be increased.

If the untreated sintered body produced by another method can be prepared, each step before the sintering step S108 may be replaced with a step of preparing the untreated sintered body (untreated sintered body preparation step).

The average thickness of the dense layer of the untreated sintered body is 150 μm or more, preferably 200 μm or more, and more preferably 300 μm or more. When the average thickness of the dense layer is within the above range, rapid absorption of nitrogen can be inhibited in the nitrogen absorption treatment to be described later. Accordingly, generation of a by-product due to the nitrogen absorption treatment can be inhibited.

An upper limit value of the average thickness of the dense layer may not be particularly set, and may be set to, for example, 1000 μm, preferably 500 μm in consideration of a thickness capable of being stably formed.

Here, the dense layer is a region containing a small amount of foreign matters, that is, a region mainly containing a high-density portion. The average thickness of the dense layer is measured and calculated by the following procedure.

First, a cross-section of the untreated sintered body is observed with an electron microscope, and a range M of, for example, 100 μm×100 μm in contact with a surface on an observation image is selected. Next, binarization image processing is performed on the range M, and the high-density portion and the foreign matters are identified by using the fact that a concentration differs due to differences in density and composition. Next, an area ratio and an average diameter of the foreign matters are calculated. The area ratio is a ratio of a total area of the foreign matters reflected in the range M to an area of the range M. In addition, the average diameter is a value obtained by averaging 10 measured values obtained by randomly selecting 10 foreign matters reflected in the range M and measuring diameters thereof. When the number of foreign matters reflected in the range M is less than 10, the average diameter is a value obtained by averaging measured values for all the foreign matters.

The area ratio and the average diameter of the foreign matters calculated as above are examined by changing a length of one side of the square range M to determine whether the area ratio and the average diameter satisfy a condition that the area ratio is 0.50% or less and the average diameter is 2.5 μm or less. A maximum length when the condition is satisfied is the thickness of the dense layer. Then, the average thickness of the dense layer is obtained by measuring the thickness at 10 or more positions and calculating an average value.

### 3.5. Nitrogen Absorption Step

In the nitrogen absorption step S110, the untreated sintered body is subjected to the nitrogen absorption treatment. Accordingly, nitrogen atoms are allowed to intrude into the dense layer and subjected to solid solution to obtain the sintered metal body 1 having the interstitial nitrogen solid solution layer NL having an average thickness of 200 μm or more.

A treatment condition in the nitrogen absorption treatment is not particularly limited as long as the nitrogen absorption treatment is a treatment of heating the untreated sintered body in presence of nitrogen. Since the untreated sintered body has the dense layer as described above, rapid absorption of nitrogen in the nitrogen absorption treatment is inhibited and generation of a by-product such as Cr₂N is inhibited. Accordingly, it is possible to obtain the interstitial nitrogen solid solution layer NL containing a small amount of the by-product, and to obtain the sintered metal body 1 having high corrosion resistance.

As an example, a partial pressure of nitrogen gas in a nitrogen atmosphere in which the nitrogen absorption treatment is performed is preferably 0.02 MPa or more and 0.18 MPa or less, and more preferably 0.05 MPa or more and 0.15 MPa or less. In addition, a treatment temperature of the nitrogen absorption treatment is preferably 1150° C. or higher and 1300° C. or lower, and more preferably 1150° C. or higher and 1250° C. or lower. Further, a heating time (treatment time) at this treatment temperature is preferably 60 minutes or longer, more preferably 90 minutes or longer and 300 minutes or shorter, and still more preferably 120 minutes or longer and 240 minutes or shorter.

According to the treatment condition described above, the dense layer of the untreated sintered body can slowly absorb nitrogen. That is, since a sintered body having no dense layer contains more gaps than a molten material, absorption of nitrogen rapidly proceeds. On the other hand, in the untreated sintered body having the dense layer, since an absorption rate of nitrogen is low, generation of a by-product due to excessive absorption of nitrogen can be inhibited. As a result, an amount of the by-product generated in the interstitial nitrogen solid solution layer NL can be particularly reduced.

Nitrogen is an austenite-forming element, so that austenite formation proceeds in the interstitial nitrogen solid solution layer NL. Accordingly, a high hardness and high corrosion resistance derived from an austenite structure are obtained in the interstitial nitrogen solid solution layer NL.

The content of N in the sintered metal body 1 can be adjusted by the partial pressure of the nitrogen gas, the treatment time, and the like. For example, the content of N in the sintered metal body 1 can be increased by increasing the partial pressure of the nitrogen gas or increasing the treatment time.

However, when the partial pressure of the nitrogen gas is lower than the lower limit value, nitrogen may not be sufficiently absorbed depending on the thickness of the dense layer. On the other hand, when the partial pressure of the nitrogen gas exceeds the upper limit value, absorption of nitrogen may rapidly proceed depending on the thickness of the dense layer. When the absorption of nitrogen rapidly proceeds, there is a concern that an austenite cannot be formed to a sufficient depth.

In the nitrogen absorption treatment, the untreated sintered body may be heated under the above treatment condition and then rapidly cooled. The generation of the by-product can be inhibited due to the rapid cooling of the untreated sintered body subjected to the nitrogen absorption treatment. By using the untreated sintered body having the dense layer described above, the rapid absorption of nitrogen in the nitrogen absorption treatment can be inhibited, and thus relaxation of a rapid cooling condition is also allowed. That is, even when the rapid cooling condition is not strictly set, the interstitial nitrogen solid solution layer NL containing a small amount of the by-product can be efficiently obtained. Examples of a rapid cooling method include water cooling and oil cooling.

A cooling rate during the rapid cooling is not particularly limited, and is preferably 50° C./sec or more, and more preferably 100° C./sec or more. Accordingly, it is possible to more effectively inhibit the generation of the by-product in the interstitial nitrogen solid solution layer NL.

### 4. Effect of Embodiment

As described above, the sintered metal body 1 according to the embodiment contains the composition of ferritic stainless steel, nitrogen, and impurities and has the interstitial nitrogen solid solution layer NL which has an average thickness of 200 μm or more and in which nitrogen atoms are in a form of a solid solution. In addition, the Vickers hardness at a position of a depth of 200 μm from the surface SF is 250 or more.

According to such a configuration, since the composition of ferritic stainless steel is contained, the sintered metal body 1 having a Ni-free characteristic is obtained. Such a sintered metal body 1 can be applied to, for example, a product that is less likely to cause adverse effects when touched by a person allergic to metal. In addition, according to the above-described configuration, nitrogen atoms intrude into the interstitial nitrogen solid solution layer NL and are subjected to solid solution to obtain an austenite structure. Accordingly, since the interstitial nitrogen solid solution layer NL is insusceptible to corrosion, the sintered metal body 1 having high corrosion resistance is obtained.

The sintered metal body 1 preferably has a relative density of 99.0% or more. According to such a sintered metal body 1, mechanical properties, a hardness, and corrosion resistance of the sintered metal body are particularly favorable.

In the sintered metal body 1, a pitting potential is preferably 700 mV or more. The pitting potential is a potential at which a current density measured according to method B among methods of pitting potential measurement for stainless steel defined in JIS G 0577:2014 is 100 μA/cm².

By satisfying such a pitting potential, corrosion of the sintered metal body 1 is sufficiently inhibited, and particularly favorable corrosion resistance is obtained.

The sintered metal body 1 preferably contains C and Nb having a content of 0.05 mass % or more and 1.50 mass % or less. C/Nb is preferably 0.10 or more and 1.80 or less, in which C/Nb is the ratio of the content of C to the content of Nb.

Accordingly, in the sintered metal body 1, it is possible to ensure a sufficient thickness for the interstitial nitrogen solid solution layer NL, and it is possible to inhibit a decrease in a sintering density and generation of a precipitate. As a result, it is possible to obtain the sintered metal body 1 having the interstitial nitrogen solid solution layer NL that has a particularly high hardness and corrosion resistance.

The method for producing a sintered metal body according to the embodiment includes the untreated sintered body preparation step and the nitrogen absorption step S110. In the untreated sintered body preparation step, the untreated sintered body containing the composition of ferritic stainless steel and impurities and having, on a surface thereof, the dense layer having an average thickness of 150 μm or more is prepared. In the nitrogen absorption step S110, by subjecting the untreated sintered body to the nitrogen absorption treatment, nitrogen atoms are subjected to solid solution in the dense layer, and a sintered metal body is obtained which has an interstitial nitrogen solid solution layer having an average thickness of 200 μm or more.

According to such a method for producing a sintered metal body, the sintered metal body having a Ni-free characteristic, high corrosion resistance, and high wear resistance can be efficiently produced.

The nitrogen absorption treatment is preferably a treatment in which the untreated sintered body is heated at a treatment temperature of 1150° C. or higher and 1300° C. or lower for a treatment time of 60 minutes or longer in a nitrogen atmosphere in which a partial pressure of nitrogen gas is 0.02 MPa or more and 0.18 MPa or less.

By performing such a nitrogen absorption treatment, the dense layer of the untreated sintered body can gradually absorb nitrogen. As a result, an amount of a by-product generated in the interstitial nitrogen solid solution layer NL can be particularly reduced.

The nitrogen atmosphere may have a total pressure equal to an atmospheric pressure or higher than the atmospheric pressure as long as the nitrogen atmosphere contains nitrogen gas.

Although the sintered metal body and the method for producing a sintered metal body according to the present disclosure have been described above based on preferred embodiments, the present disclosure is not limited thereto. For example, the sintered metal body may be a sintered body produced by using a metal powder different from the above-described sintering metal powder.

### EXAMPLES

Next, Examples of the present disclosure will be described.

### 5. Production of Sintered Metal Body

### 5.1. Sample No. 1

First, a kneaded material (composition) containing a sintering metal powder produced by a water atomization method and a binder was prepared. As the sintering metal powder, a powder having a composition shown in Table 1 and an average particle diameter of 8.0 μm was used. In addition, a mixture of polypropylene and wax was used as the binder. A mixing ratio of the binder in the kneaded material was 10 mass %.

Next, the kneaded material was molded by an injection molding machine to obtain a molded body. A shape of the molded body was a rectangular parallelepiped body having a length of 15 mm, a width of 15 mm, and a height of 3 mm. Next, the molded body was subjected to a debindering treatment to obtain a debindered body. The debindering treatment was a treatment of heating the molded body at 450° C. for 2 hours in a nitrogen atmosphere.

Next, the debindered body was subjected to a sintering treatment to obtain an untreated sintered body. The sintering treatment was a treatment of heating the debindered body at 1250° C. for 3 hours in an argon atmosphere. In addition, an average thickness of a dense layer of the untreated sintered body is as shown in Table 2.

Next, the untreated sintered body was subjected to a nitrogen absorption treatment to obtain a sintered metal body. A treatment condition in the nitrogen absorption treatment is as shown in Table 2. The nitrogen atmosphere is an atmosphere of 100% nitrogen gas, and a total pressure of the nitrogen atmosphere is equal to a partial pressure of nitrogen.

### 5.2. Samples No. 2 to No. 11

Sintered metal bodies were obtained in the same manner as in Sample No. 1 except that the composition of the sintering metal powder was changed as shown in Table 1, and the configuration of the untreated sintered body and the condition in the nitrogen absorption treatment were changed as shown in Table 2.

### 5.3. Sample No. 12

A sintered metal body was obtained in the same manner as in Sample No. 1 except that the nitrogen absorption treatment was omitted.

### 5.4. Samples No. 13 to No. 18

Sintered metal bodies were obtained in the same manner as in Sample No. 1 except that the composition of the sintering metal powder was changed as shown in Table 1, and the configuration of the untreated sintered body and the condition in the nitrogen absorption treatment were changed as shown in Table 2.

TABLE 1

| | Example/ | Composition of sintering metal powder | | | | | | | | | | | | | |
|---|---|---|---|---|---|---|---|---|---|---|---|---|---|---|---|
| Sample | Comparative | C | O | Si | Mn | P | S | Cu | Ni | Cr | Mo | Nb | Fe | C/Nb | C + Nb |
| No. | Example | mass % | | | | | | | | | | | | — | mass % |
| No. 1 | Example | 0.187 | 0.278 | 0.44 | 0.01 | 0.005 | 0.005 | 0.04 | 0.00 | 21.30 | 2.40 | 0.20 | Remainder | 0.94 | 0.39 |
| No. 2 | Example | 0.110 | 0.311 | 0.25 | 0.01 | 0.003 | 0.010 | 0.05 | 0.01 | 20.80 | 2.21 | 0.35 | Remainder | 0.31 | 0.46 |
| No. 3 | Example | 0.214 | 0.335 | 0.38 | 0.01 | 0.005 | 0.008 | 0.06 | 0.01 | 21.18 | 2.36 | 0.53 | Remainder | 0.40 | 0.74 |
| No. 4 | Example | 0.396 | 0.342 | 0.56 | 0.02 | 0.010 | 0.003 | 0.10 | 0.02 | 21.75 | 2.53 | 0.70 | Remainder | 0.57 | 1.10 |
| No. 5 | Example | 0.198 | 0.368 | 0.44 | 0.02 | 0.006 | 0.009 | 0.05 | 0.00 | 21.17 | 2.36 | 1.05 | Remainder | 0.19 | 1.25 |
| No. 6 | Example | 0.412 | 0.356 | 0.41 | 0.02 | 0.005 | 0.009 | 0.04 | 0.02 | 21.54 | 2.25 | 0.34 | Remainder | 1.21 | 0.75 |
| No. 7 | Example | 0.187 | 0.278 | 0.44 | 0.01 | 0.005 | 0.005 | 0.04 | 0.00 | 21.30 | 2.40 | 0.20 | Remainder | 0.94 | 0.39 |
| No. 8 | Example | 0.187 | 0.278 | 0.44 | 0.01 | 0.005 | 0.005 | 0.04 | 0.00 | 21.30 | 2.40 | 0.20 | Remainder | 0.94 | 0.39 |
| No. 9 | Example | 0.187 | 0.278 | 0.44 | 0.01 | 0.005 | 0.005 | 0.04 | 0.00 | 21.30 | 2.40 | 0.20 | Remainder | 0.94 | 0.39 |
| No. 10 | Example | 0.187 | 0.278 | 0.44 | 0.01 | 0.005 | 0.005 | 0.04 | 0.00 | 21.30 | 2.40 | 0.20 | Remainder | 0.94 | 0.39 |
| No. 11 | Example | 0.187 | 0.278 | 0.44 | 0.01 | 0.005 | 0.005 | 0.04 | 0.00 | 21.30 | 2.40 | 0.20 | Remainder | 0.94 | 0.39 |
| No. 12 | Comparative | 0.187 | 0.278 | 0.44 | 0.01 | 0.005 | 0.005 | 0.04 | 0.00 | 21.30 | 2.40 | 0.20 | Remainder | 0.94 | 0.39 |
| | Example | | | | | | | | | | | | | | |
| No. 13 | Comparative | 0.187 | 0.278 | 0.44 | 0.01 | 0.005 | 0.005 | 0.04 | 0.00 | 21.30 | 2.40 | 0.20 | Remainder | 0.94 | 0.39 |
| | Example | | | | | | | | | | | | | | |
| No. 14 | Comparative | 0.020 | 0.275 | 0.44 | 0.02 | 0.005 | 0.008 | 0.06 | 0.01 | 21.11 | 2.33 | 0.01 | Remainder | 2.00 | 0.03 |
| | Example | | | | | | | | | | | | | | |
| No. 15 | Comparative | 0.030 | 0.313 | 0.23 | 0.01 | 0.003 | 0.010 | 0.05 | 0.01 | 20.65 | 2.23 | 0.15 | Remainder | 0.20 | 0.18 |
| | Example | | | | | | | | | | | | | | |
| No. 16 | Comparative | 0.132 | 0.324 | 0.36 | 0.01 | 0.005 | 0.007 | 0.07 | 0.01 | 21.23 | 2.34 | 0.02 | Remainder | 6.60 | 0.15 |
| | Example | | | | | | | | | | | | | | |
| No. 17 | Comparative | 1.256 | 0.356 | 0.54 | 0.02 | 0.008 | 0.004 | 0.11 | 0.02 | 21.64 | 2.56 | 0.23 | Remainder | 5.46 | 1.49 |
| | Example | | | | | | | | | | | | | | |
| No. 18 | Comparative | 0.125 | 0.372 | 0.42 | 0.02 | 0.012 | 0.009 | 0.09 | 0.02 | 21.32 | 2.38 | 1.68 | Remainder | 0.07 | 1.8 |
| | Example | | | | | | | | | | | | | | |

In Table 1, those corresponding to the present disclosure are indicated by “Example”, and those not corresponding to the present disclosure are indicated by “Comparative Example”.

### 6. Configuration of Untreated Sintered Body

Each untreated sintered body obtained in Examples and Comparative Examples was cut. Then, a cut surface was polished, and the polished surface was observed with an electron microscope.

Next, an average thickness of the dense layer was calculated based on an observation image. Calculation results are shown in Table 2.

### 7. Configuration of Sintered Metal Body

### 7.1. Content of N

For each sintered metal body obtained in Examples and Comparative Examples, a content of N was measured. Measurement results are shown in Table 2.

### 7.2. Observation of Cross Section

Each sintered metal body obtained in Examples and Comparative Examples was cut. Then, a cut surface was polished, and the polished surface was observed with an electron microscope.

Next, an average thickness of an interstitial nitrogen solid solution layer was calculated based on an observation image. Calculation results are shown in Table 2.

FIG. 4 shows an observation image of a cut surface of a sintered metal body in Sample No. 1. As shown in FIG. 4, in the sintered metal body in Sample No. 1, it is possible to confirm an interstitial nitrogen solid solution layer spreading from the surface toward the inside. In addition, it can also be confirmed that a ferrite structure remains inside the interstitial nitrogen solid solution layer.

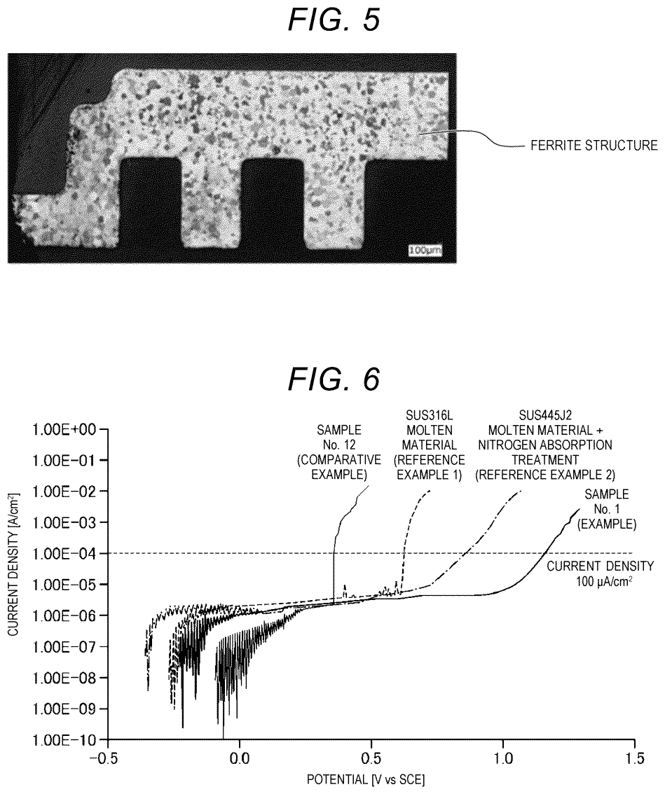

On the other hand, FIG. 5 shows an observation image of a cut surface of a sintered metal body in Sample No. 12. As shown in FIG. 5, in the sintered metal body in Sample No. 12, since the nitrogen absorption treatment is omitted, no interstitial nitrogen solid solution layer can be confirmed.

### 7.3. Vickers Hardness

A Vickers hardness was measured at a position of a depth of 200 μm from the surface and a position of a depth of 400 μm from the surface in the cut surface of each sintered metal body obtained in Examples and Comparative Examples. Measurement results are shown in Table 2.

### 8. Evaluation of Sintered Metal Body

### 8.1. Relative Density

For each sintered metal body obtained in Examples and Comparative Examples, a relative density was calculated according to a method defined in JIS Z 2501:2000. Calculation results are shown in Table 2.

### 8.2. Corrosion Resistance

For each sintered metal body obtained in Examples and Comparative Examples, a pitting potential was measured according to method B among methods of pitting potential measurement for stainless steel defined in JIS G 0577:2014. The measured pitting potential was evaluated according to the following evaluation criteria. Evaluation results are shown in Table 2.
A: The pitting potential is 900 mV or more.
B: The pitting potential is 800 mV or more and less than 900 mV.
C: The pitting potential is 700 mV or more and less than 800 mV.
D: The pitting potential is 600 mV or more and less than 700 mV.
E: The pitting potential is 500 mV or more and less than 600 mV.
F: The pitting potential is less than 500 mV.

### 8.3. Wear Resistance

Each sintered metal body obtained in Examples and Comparative Examples was subjected to a friction and wear test defined in JIS K 7218:1986. Specifically, first, a test pin was produced from austenitic stainless steel SUS316L, and a test disk was produced from each sintered metal body obtained in Examples and Comparative Examples.

Next, the test pin and the test disk were set in a pin-on-disk tester which is a reciprocating friction and wear tester, and the test pin was reciprocally slid back and forth on a surface of the test disk. Then, a wear amount after reciprocally sliding along a length of 10 mm 600 times was measured at an air temperature of 25° C. Then, with reference to the wear amount measured for the sintered metal body in Sample No. 12, the wear amount measured for each sintered metal body in Samples No. 1 to No. 18 was relatively evaluated in light of the following evaluation criteria. Evaluation results are shown in Table 2.
A: The wear amount is particularly less than the reference.
B: The wear amount is less than the reference.
C: The wear amount is slightly less than the reference.
D: The wear amount is slightly larger than the reference.
E: The wear amount is larger than the reference.
F: The wear amount is particularly larger than the reference.

TABLE 2

| | | Configuration | | | | | | | | | | |
|---|---|---|---|---|---|---|---|---|---|---|---|---|
| | | of untreated | | | | | | | | | | |
| | | sintered body | Condition in nitrogen | | | Configuration of sintered metal body | | | | | | |
| | | Average | absorption treatment | | | | Average | Vickers | Vickers | | | |
| | | thick- | Partial | Treat- | | Con- | thickness of | hardness at | hardness at | Evaluation result of sintered | | |
| | | ness of | pressure | ment | Treat- | tent | interstitial | position of | position of | metal body | | |
| | Example/ | dense | of | temper- | ment | of N | nitrogen solid | depth of | depth of | Relative | Corrosion | Wear |
| Sample | Comparative | layer | nitrogen | ature | time | mass | solution layer | 200 μm | 400 μm | density | resistance | resistance |
| No. | Example | μm | MPa | ° C. | Minute | % | μm | — | — | % | — | — |
| No. 1 | Example | 300 | 0.10 | 1200 | 150 | 0.15 | 450 | 325 | 325 | 99.5 | A | A |
| No. 2 | Example | 350 | 0.10 | 1200 | 300 | 0.30 | 500 | 350 | 330 | 99.6 | A | A |
| No. 3 | Example | 400 | 0.10 | 1200 | 450 | 0.70 | 550 | 375 | 350 | 99.7 | A | A |
| No. 4 | Example | 300 | 0.10 | 1200 | 150 | 0.15 | 450 | 325 | 250 | 99.3 | A | A |
| No. 5 | Example | 150 | 0.10 | 1200 | 150 | 0.05 | 200 | 250 | 200 | 98.7 | C | B |
| No. 6 | Example | 200 | 0.10 | 1200 | 150 | 0.10 | 250 | 275 | 220 | 99.0 | B | B |
| No. 7 | Example | 300 | 0.03 | 1250 | 450 | 0.10 | 250 | 275 | 300 | 99.5 | A | B |
| No. 8 | Example | 300 | 0.05 | 1200 | 300 | 0.10 | 300 | 300 | 300 | 99.5 | A | A |
| No. 9 | Example | 300 | 0.15 | 1150 | 150 | 0.15 | 350 | 350 | 300 | 99.5 | A | A |
| No. 10 | Example | 300 | 0.18 | 1200 | 80 | 0.03 | 250 | 275 | 220 | 99.5 | B | B |
| No. 11 | Example | 300 | 0.10 | 1200 | 300 | 0.20 | 450 | 325 | 300 | 99.5 | A | A |
| No. 12 | Comparative | 300 | — | — | — | 0.00 | 0 | 200 | 200 | 99.5 | F | F |
| | Example | | | | | | | | | | | |
| No. 13 | Comparative | 300 | 0.20 | 1200 | 150 | 0.05 | 200 | 225 | 205 | 99.5 | F | C |
| | Example | | | | | | | | | | | |
| No. 14 | Comparative | 100 | 0.10 | 1200 | 150 | 1.20 | 150 | 210 | 200 | 98.3 | F | D |
| | Example | | | | | | | | | | | |
| No. 15 | Comparative | 100 | 0.10 | 1200 | 150 | 1.20 | 150 | 215 | 200 | 98.4 | E | D |
| | Example | | | | | | | | | | | |
| No. 16 | Comparative | 50 | 0.10 | 1200 | 150 | 1.50 | 100 | 205 | 200 | 99.3 | F | C |
| | Example | | | | | | | | | | | |
| No. 17 | Comparative | 150 | 0.01 | 1300 | 150 | 0.80 | 150 | 220 | 200 | 98.1 | E | C |
| | Example | | | | | | | | | | | |
| No. 18 | Comparative | 100 | 0.10 | 1200 | 150 | 1.20 | 150 | 215 | 200 | 99.2 | F | C |
| | Example | | | | | | | | | | | |

As shown in Table 2, it was observed that each sintered metal body in Examples had a sufficiently thick interstitial nitrogen solid solution layer and had a sufficiently high Vickers hardness at the position of a depth of 200 μm from the surface, as compared to each sintered metal body in Comparative Examples. It was also observed that each sintered metal body in Examples had both favorable corrosion resistance and favorable wear resistance.

In each sintered metal body in Examples, it was also observed that the Vickers hardness at the position of a depth of 400 nm from the surface was sufficiently high, and a difference in the Vickers hardness between the position of 200 nm and the position of 400 nm was small. Therefore, it is considered that a stable austenite structure is formed to a sufficient depth in each sintered metal body in Examples.

FIG. 6 shows graphs showing a relationship between a potential and a current density obtained from the sintered metal body in Sample No. 1 (Example) and a relationship between a potential and a current density obtained from the sintered metal body in Sample No. 12 (Comparative Example). In FIG. 6, a broken line is drawn at a position where the current density is 100 μA/cm². A potential corresponding to an intersection between the broken line and each graph is the pitting potential. In addition, FIG. 6 also shows a relationship between a potential and a current density obtained from a molten material of austenitic stainless steel (SUS316L) as “Reference Example 1”. Further, in FIG. 6, a relationship between a potential and a current density obtained from a sample obtained by subjecting a molten material of ferritic stainless steel (SUS445J2) to a nitrogen absorption treatment is shown together as “Reference Example 2”. A treatment condition in the nitrogen absorption treatment performed on the sample in Reference Example 2 is a nitrogen partial pressure of 0.20 MPa, a treatment temperature of 1200° C., and a treatment time of 300 minutes.

From the graph shown in FIG. 6, it was found that the pitting potential obtained from the sintered metal body in Sample No. 1 (Example) was sufficiently higher than the pitting potential obtained from the sintered metal body in Sample No. 12 (Comparative Example). In particular, the pitting potential obtained from the sintered metal body in Sample No. 1 is higher than the pitting potential obtained from the molten material of the austenitic stainless steel, which is generally considered to have high corrosion resistance, and the pitting potential obtained from the molten material of the ferritic stainless steel subjected to the nitrogen absorption treatment. Therefore, it was observed that the corrosion resistance exhibited by each sintered metal body in Examples was equal to or better than that of the austenitic stainless steel.

What is claimed is:

1. A sintered metal body comprising:
a composition of ferritic stainless steel;
nitrogen; and
impurities, wherein
the sintered metal body has an interstitial nitrogen solid solution layer which has an average thickness of 200 μm or more and in which nitrogen atoms are in a form of a solid solution, and
a Vickers hardness at a position of a depth of 200 μm from a surface is 250 or more.

2. The sintered metal body according to claim 1, wherein
the sintered metal body has a relative density of 99.0% or more.

3. The sintered metal body according to claim 1, wherein
a potential at which a current density measured according to method B among methods of pitting potential measurement for stainless steel defined in JIS G 0577:2014 is 100 μA/cm² is 700 mV or more.

4. The sintered metal body according to claim 1, further comprising:
C; and
Nb having a content of 0.05 mass % or more and 1.50 mass % or less, wherein
C/Nb is 0.10 or more and 1.80 or less, where C/Nb is a ratio of a content of C to the content of Nb.

5. A method for producing a sintered metal body, comprising:
preparing an untreated sintered body containing a composition of ferritic stainless steel and impurities and having, on a surface thereof, a dense layer having an average thickness of 150 μm or more; and
subjecting the untreated sintered body to a nitrogen absorption treatment to form a solid solution of nitrogen atoms in the dense layer and obtain a sintered metal body having an interstitial nitrogen solid solution layer having an average thickness of 200 μm or more.

6. The method for producing a sintered metal body according to claim 5, wherein
the nitrogen absorption treatment is a treatment in which the untreated sintered body is heated at a treatment temperature of 1150° C. or higher and 1300° C. or lower for a treatment time of 60 minutes or longer in a nitrogen atmosphere in which a partial pressure of nitrogen gas is 0.02 MPa or more and 0.18 MPa or less.
